(19) United States
(12) Patent Application Publication
(10) Pub. No.: US 2010/0082808 A1
(43) Pub. Date: Apr. 1, 2010

(54) SYSTEM AND METHOD FOR AUTOMATICALLY DELIVERING RELEVANT INTERNET CONTENT

(75) Inventors: Dimitri Vaynblat, San Carlos, CA (US); Kira Makagon, Hillsborough, CA (US); Kiril Tsemekhman, San Francisco, CA (US)

Correspondence Address: K&L Gates LLP;IP Docketing, 630 Hansen Way, Palo Alto, CA, 94304, US

(73) Assignee: Red Aril, Inc., San Mateo, CA (US)

(21) Appl. No.: 12/569,613

(22) Filed: Sep. 29, 2009

Related U.S. Application Data
(60) Provisional application No. 61/101,150, filed on Sep. 29, 2008.

(51) Int. Cl. G06F 15/173; G06F 3/01

(52) U.S. Cl. 709/224; 715/760

(57) ABSTRACT

This invention discloses a system and method for automatically delivering relevant Internet content to a browser, the system comprises a webpage embedded with a generic pixel tag stored in a first server, the generic pixel tag being configured to cause a retrieval of at least one predetermined attribute of the webpage from a browser that is viewing the webpage; and a rule engine residing in a second server for determining one or more Internet contents based on the predetermined attribute for being sent to the browser, wherein linkages between the webpage and the one or more Internet contents are not hard coded in the webpage.

### CROSS REFERENCE

This application claims the benefits of U.S. Provisional Patent Application Ser. No. 61/101,150, which was filed on Sep. 29, 2008 and entitled “Generic pixel tags”.

### BACKGROUND

The present invention relates generally to Internet applications, and, more particularly, to a system and method for automatically delivering relevant Internet contents.

In delivering web pages through the Internet, there are a number of techniques used to monitor which pages a user visits and what a user does on a webpage. A pixel tag, also called a web bug or a web beacon, is one of the techniques often used to track who is reading a webpage or email, when, and from what computer. A pixel tag can also be used to see if an e-mail was read or forwarded to other addresses. Many webpages are not self-contained within their own websites. They may refer to content from other websites or servers. When a web browser prepares such a webpage for display, a request is automatically sent to other web sites and servers for the additional content, These requests typically include an IP address of the requesting computer, a time the content was requested, a type of web browser that made the request, and the existence of cookies previously set by the server. The server can store all of this information, and associate it with a unique tracking token attached to the content request.

As an example of the way pixel tags can make user logging easier, consider a company that owns a network of sites. This company may have a network that requires all images to be stored on one host computer while the pages themselves are stored elsewhere. They could use pixel tags to count and recognize users traveling around the different servers on the network. Rather than gathering statistics and managing cookies on all their servers separately, they can use pixel tags to keep them all together.

A pixel tag typically generates a request for a transparent graphic image, usually 1 pixel×1 pixel, or for a Java script, which is placed in a source file of the webpage and is used to monitor the behavior of the user visiting the Web site. For example, the following are two pixel tags recently found on People magazine online and LA Times pages represented as HTML IMG tags:

img src=‘http://pixel.quantserve.comlpixellp-5dyPa639Irglw.gif?tags=News’
style=‘display: none;’ border=‘O’ height=‘1’ width=‘1’,
http://pixeI1739.everesttech.nel/1739/p?ev_transid=122233805919528058309&ev_La times.com˜business_sCpageview=1

These pixel tags are placed on the home page of People Magazine and on the Business section page of LA Times, respectively, to provide “hit” information about visitors to Quantcast and Efficient Frontier, Internet analytics and campaign optimization companies. The specific information that the pixel calls provides to an advertisement network or to the analytics company is hardcoded into the pixel tag as is seen in these two examples. When a browser interprets a pixel tag, the browser is caused to automatically send a request to a server defined in the pixel tag and communicate the information pertaining to the page or a site (e.g. tags=“News” or “business” in these examples).

FIG. 1 is a block diagram illustrating a conventional webpage category determining system 100. A pixel tag 110 used for identifying interests of Internet users is parameterized by a page category, and is embedded in a webpage 108 that is stored in a publisher server 104. The pixel tag 110 may contain a string that attributes a webpage to a particular category, e.g. Technology News. The pixel tag 110 may also include a link to an object on an advertisement network server 106. When a browser 102 sends a request for the web page 108 that contains the pixel tag 110 to the server 104, as a response, the server 104 releases the web page 108, with embedded pixel tag 110, to the browser 102. Upon detecting the presence of the pixel tag 110 in the received webpage 108, the browser 102 automatically sends a request to the advertisement network server 106 per the instruction or execution of the pixel tag 110. Upon receiving the pixel tag request, the advertisement network server 106 retrieves a category of the webpage from the pixel tag, e.g., Technology News. Then the advertisement network server 106 knows that the user is interested in technology news. In response to the request from the browser, the advertisement network server 106 releases an object, or pixel, referred to by the pixel tag 110 to the browser 102. If there are additional pixel tags in the web page, each pertaining to a server, the browser 102 will send these additional pixel tags to their corresponding servers.

However, editing these pixel tags could be tedious and costly. In particular, when the data sent with the pixel tag includes some specific information about the page or group of pages, e.g. the topic or ‘channel’ this page represents. Each time the pixel is edited, added or changed, the webpage has to be redesigned. Continued the above example of the People Magazine or LA Times pages, the two pixel tags must be rewritten if, for example, the attribution of the page changes from News to Sports; both the attribution and the editing have to be done by the Publisher and communicated to the data receiving entity. Given so many webpages on a website, it would be prohibitively expensive to rewrite the pages, add a pixel tag to every new page requires prior knowledge of the attributes of the page as well as edit a pixel to include these attributes.

As such, what is desired is a system and method that will not require rewriting or editing the pixel tags when there is a need to change the attributes of the pages or to cover new pages.

### SUMMARY

This invention discloses a system and method for automatically delivering relevant Internet content to a browser. The Internet content delivering system comprises a webpage embedded with a generic pixel tag stored in a first server, the generic pixel tag being configured to cause a retrieval of at least one predetermined attribute of the webpage from a browser that is viewing the webpage; and a rule engine residing in a second server for determining one or more Internet contents based on the predetermined attribute for being sent to the browser, wherein linkages between the webpage and the one or more Internet contents are not hard coded in the webpage.

The method for automatically delivering relevant Internet contents comprises releasing a webpage embedded with a generic pixel tag by a first server to a browser; obtaining at least one predetermined attribute of the webpage through an execution of the generic pixel tag on the browser; sending the predetermined attribute to a rule engine residing in a second server for determining one or more category information of the webpage; and releasing one or more Internet contents appropriate to the one or more category information to the browser, wherein linkages between the webpage and the one or more Internet contents are not hard coded in the webpage.

The construction and method of operation of the invention, however, together with additional objectives and advantages thereof will be best understood from the following description of specific embodiments when read in connection with the accompanying drawings.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

FIG. 1 is a block diagram illustrating an Internet content delivering system utilizing a conventional pixel tag.

FIG. 2A is a block diagram illustrating an Internet content delivering system utilizing a generic pixel tag according a first embodiment of the present invention.

FIG. 2B is a flowchart diagram illustrating an operating process of the Internet content delivering system of FIG. 2A.

FIG. 3A is a block diagram illustrating details of the rule engine of FIG. 2A.

FIG. 3B shows an illustration of matching interest categories of a user and advertisement contents by the optimizer of FIG. 3A.

FIG. 4 is a block diagram illustrating an alternative Internet content delivering system according to a second embodiment of the present invention.

FIG. 5 is a block diagram illustrating yet another alternative Internet content delivering system according to a third embodiment of the present invention.

### DESCRIPTION

The present invention discloses a system and method for automatically delivering relevant Internet content by utilizing generic pixel tags embedded in webpages, so that when attributes of the webpage need to be changed, the generic pixel tag need not be modified.

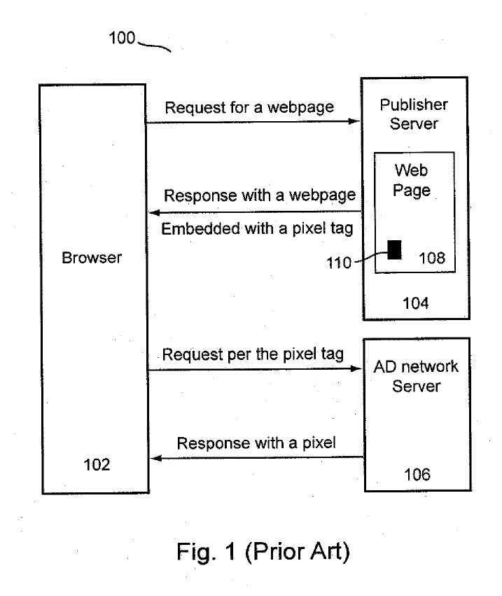

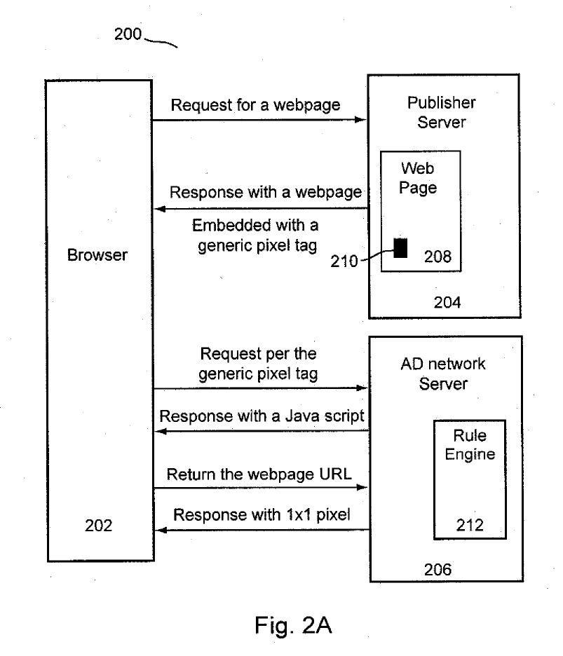

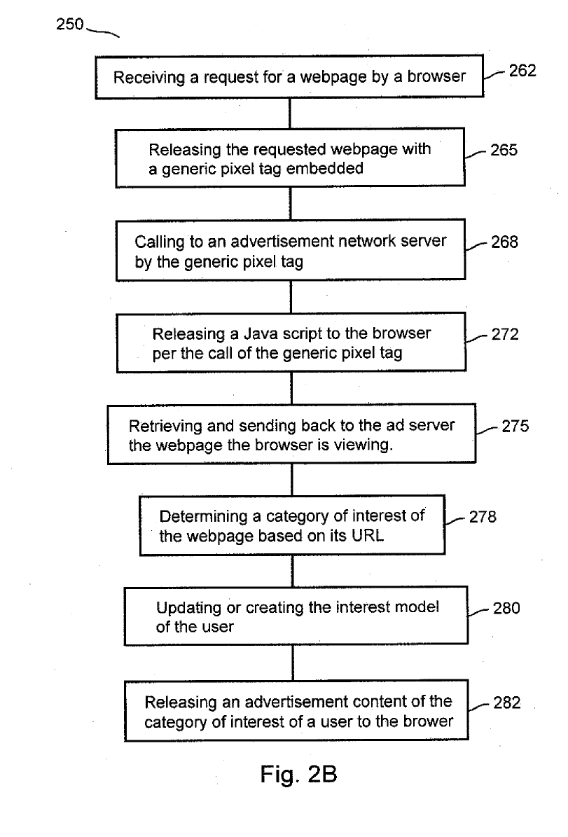

FIG. 2A is a block diagram illustrating an Internet content delivering system 200 utilizing generic pixel tags according a first embodiment of the present invention. The Internet content delivering system 200 includes a browser 202 at a user site, a server 204 of a content publisher and an advertisement network server 206, all connected to each other through the Internet. The publisher server 204 stores a webpage 208 that contains a generic pixel tag 210 which is different form the conventional pixel tag 110 of FIG. 1 in that the generic pixel tag 210 is simply a generic call to the advertisement network server 206, and the web page category information is not hard coded in the tag itself. The advertisement network server 206 is configured to respond to requests made by the generic pixel tag with scripts to retrieve the universal resource locators (URLs) the browser 202 is viewing. The scripts are typically written in Java script language. The Internet content delivering system 200 also includes a rule engine 212 that may belong to an advertisement network server 206. The rule engine 212 obtains a predetermined attribute pertaining to the original webpage 208 from the URL and determines a category of the webpage 208. The category generally reflects the interest of the user that has requested the webpage 208. This category is then used by the rule engine 212 to determine the interest model of the user. The interest model of the user represents the most current categories of interest of the user and is maintained inside the rule engine 212. Then, at an appropriate moment, the advertisement network server 206 releases an advertisement content appropriate to the category of interest of the user. Even though the above embodiment of the present invention depicts the rule engine 212 as being run by the advertisement network server 206, a skilled artisan would realize that the rule engine 212 may also reside in other servers that can communicate with the advertisement network server 206.

FIG. 2B is a flowchart diagram illustrating an operating process 250 of the Internet content delivering system 200 of FIG. 2A. The operating process 250 starts with a publisher's server 204 receiving a request for a webpage from a browser 202 in step 262. The publisher's server releases the requested webpage with an embedded generic pixel tag to the browser in step 265. The generic pixel tag makes a call to an advertisement network server 206 from the browser in step 268. Then the advertisement network server releases a Java script to the browser per the call of the generic pixel tag in step 272. The Java script retrieves and sends back to the advertisement network server the URL of the webpage the browser is viewing in step 275. A rule engine 212 residing either in the advertisement network server or elsewhere obtains attributes pertaining to the webpage from the URL and then determines a category of interest of the webpage in step 278. The rule engine further uses this category to determine the interest model of the user in step 280. Then, at an appropriate moment, advertisement content appropriate to the category of interest of the user is released to the browser by the advertisement network server in step 282. Even though Java script is used to interact with the browser here, one skilled in the art would appreciate other scripting languages that are supported by both the server and the browser may also be used.

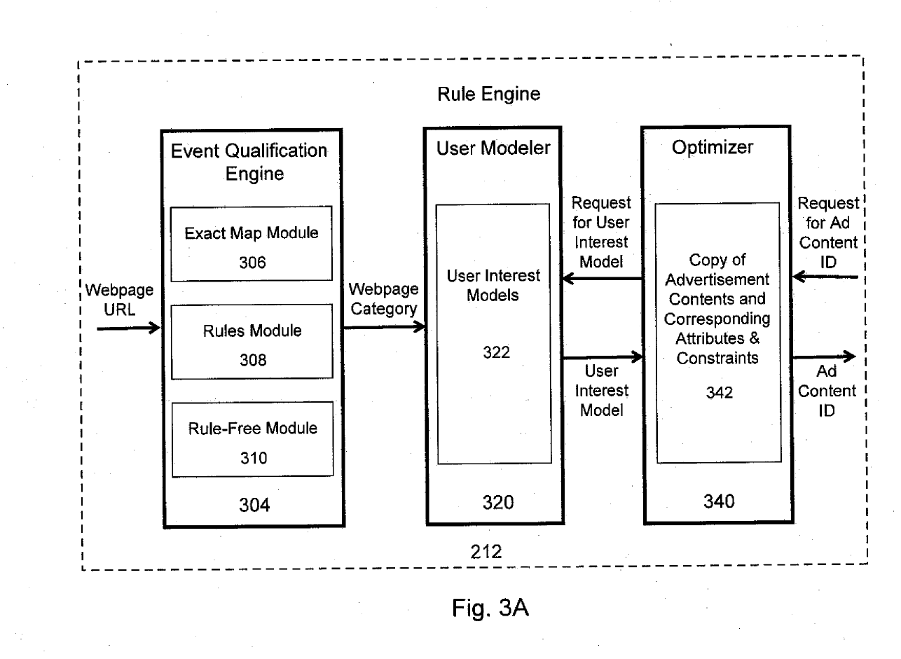

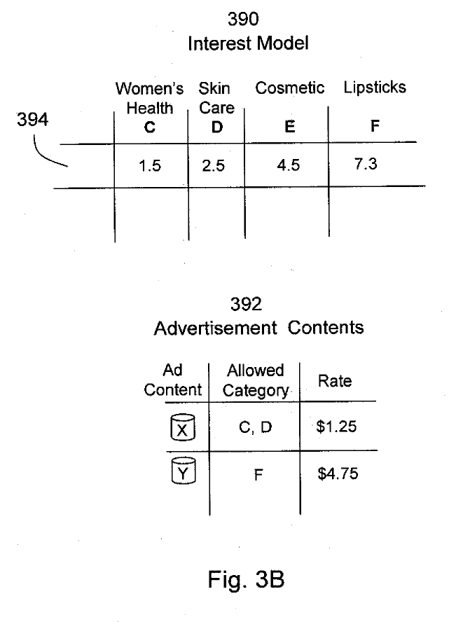

FIG. 3A is a block diagram illustrating details of the rule engine 212 of FIG. 2A. The rule engine 212 comprises three key modules: an event qualification engine 304, a user modeler 320, and an optimizer 340. The event qualification engine 304 obtains a predetermined attribute pertaining to the webpage 208 viewed by the user from the URL and determines a category of the webpage 208. This webpage category is then used by the user modeler 320 to determine the interest model of the user 322. The interest model of the user represents the most current categories of interest of the user and is maintained inside the user modeler 320. The optimizer 340 maintains an up-to-date copy of the available advertisement contents of the advertisement server 206 as well as corresponding attributes, constraints, and rules of usage for each of these advertisement contents 342. When the user navigates to a webpage on which the webpage publisher wants to display advertisement content, the advertisement server 206 receives a call for advertisement content. The advertisement network server 206 relays this advertisement call request to the optimizer 340 of the rule engine 212. The optimizer 340 then calls the user modeler 320 and asks for the current interest model of the user. Upon receiving the interest model of the user, the optimizer 340 selects an advertisement content the most appropriate for the categories of interest of the user and other attributes of the advertisement call, e.g., time of the call, type of webpage on which advertisement content should be placed, etc. Then the optimizer 340 communicates to the advertisement server 206 and specifies which particular advertisement content has been selected. Then the advertisement server 206 releases the selected advertisement content to the browser.

The event qualification engine 304 is provided to qualify or categorize the webpage viewed by the user by dynamically analyzing predetermined attribute pertaining to the webpage. The event qualification engine 304 qualifies the webpage per a finite number of categories, each related to one type of user interest or other user attribute, such as demographics, psychographics, or geographic location. For example, a user browsing websites featuring Ford or Toyota cars indicate that the user is now interested in automobiles, and thus the user browsing event is qualified into a “car” category.

As an example, the event qualification engine 304 includes an exact map module 306, a rule module 308 and a rule-free module 310. The exact map module 306 provides an exact matching between a received webpage URL and one of the categories, namely each category corresponds to one or more URLs (e.g. http://www.cnn.com/TECH/ is attributed to Technology-News category). The rule module 308 provides definitive matching rules between a category and a set of URLs from a domain. In one example, there is a plurality of categories, each corresponding to one or more URLs. In another example, one rule may correspond to a number of pages whose URL's do not have to be known in advance, e.g., any page from the domain www.retailer.com whose URL contains 12a4 pattern is attributed to a category of Plasma TV. The rule-free module 310 uses rule-free attributes, for example, text-based page classification.

The set of attribution designs thus covers essentially any webpage, is executed dynamically, and does not involve any work on the part of the Publisher. Any change in the content of the page or in the dictionary of attributes does not lead to any additional work as they are automatically detected and determined by the underlying rules in the event qualification engine 304.

A user modeler 320 receives the webpage category and is configured to determine interest categories of the user that is viewing the webpage. In operation, the user modeler 320 receives the webpage categories for webpages viewed by the user from the event qualification engine 304 and transforms them into meaningful interest categories of the user—an interest model. In one case, an interest model comprises a user's unique demographics, geographic location, lifestyle, as well as quantified expressions of purchase intent for various products or services that may be categorized. Once the interest model is constructed, it is continuously updated and enhanced as new user click-stream data becomes available.

An interest model of a user may include one or more intent categories depending on the intent of the user for various products or services. If the user spends a significant amount of time browsing websites featuring a certain item (e.g., cars), the analysis of the data traffic may indicate that the current interest of the user is focusing on the item. If there is a category for the item, the interest model of the user now includes the category. Depending on the interests of the user, the interest model of the user may contain several intent categories, each is being weighted differently. A number may be assigned to a category in the interest model. The number may be updated over time. For a category, in general, the higher a number, the more likely a product or service corresponding to the category is attended to by the user.

Once the user interest categories are evaluated, there are many applications that can utilize the interests. For instance, a targeted advertisement based on the user interest, instead of a generic one, may be sent to the browser for display. The user modeler 320 can be part of the rule engine 212 or separated from the rule engine 212 and even reside in another server.

Again, the optimizer 340 utilizes a user interest model to work with an advertisement server 206 to select the most relevant advertisement content for a user. The optimizer 340 gets current user interest model from the user modeler 320. The optimizer 340 also maintains an up-to-date copy of the available advertisement contents of the advertisement server 206 as well as corresponding attributes, constraints, and rules of usage for each of these advertisement contents 342. In one case this is achieved through metadata synchronization between the advertisement server 206 and the optimizer 340. The optimizer 340 can be part of the rule engine 212 or separated from the rule engine 212 and even reside in another server.

When the advertisement server 206 receives a browser request for an advertisement content (an ad call) resulting from a user's request of a webpage on which the webpage publisher wants to display advertisement content, the advertisement server 206 relays this ad call request to the optimizer 340. The optimizer 340 then calls the user modeler 320 and receives the current interest model of the user. Upon receiving the interest model of the user, the optimizer selects an advertisement content the most appropriate for the categories of interest of the user and other attributes of the ad call (e.g., time of the call, type of webpage on which advertisement content should be placed, etc). Finally, the optimizer 340 communicates to the advertisement server 206 which particular advertisement content has been chosen.

In one case, given a certain user interest model, the optimizer 340 first considers all advertisement contents available in advertisement sever 206 and eliminates those for which the categories of interest of the user and other attributes of the advertisement call do not meet advertisement contents' constraints and rules of usage. For the remaining advertising contents, the optimizer 340 calculates a predicted response from the user to the advertisement content (likelihood of a click or conversion) based on the interest model of the user and other attributes of the advertisement call. With the predicted response and the rates paid by the advertisers for showing their advertisement contents, the optimizer 340 calculates projected revenue for each of the advertisement contents that could be generated from this advertisement call. Finally, the optimizer 340 selects the advertisement content with the highest projected revenue and passes the winning advertisement content identifier to the advertisement server 206.

FIG. 3B shows an illustration of matching a category in an interest model 390 and advertisement content 392. The interest model 390 includes four exemplary categories, respectively labeled as C, D, E, and F. Each of the numerals 394 for the categories indicates a relative weight of an interest in the category. As shown in FIG. 3B, the user is generally interested in “Women's Health” category but more interested in “Lipsticks” category. In reality, there may be many advertisement contents from advertisers. Each of the advertisement contents is categorized per a list of categories. As shown in FIG. 3B, there are two advertisement contents labeled respectively as X and Y, where advertisement content X is categorized as “C”, or “D” and advertisement content Y is categorized as “F”. Because category F is more specific than category “C”, or “D”, therefore the charge for publishing advertisement content Y is in general more than publishing advertisement content X. In operation, when the user is seen at a website and there is an advertising opportunity in the website, preferably, advertisement content Y is selected from the advertisement contents 392 to be served to the user.

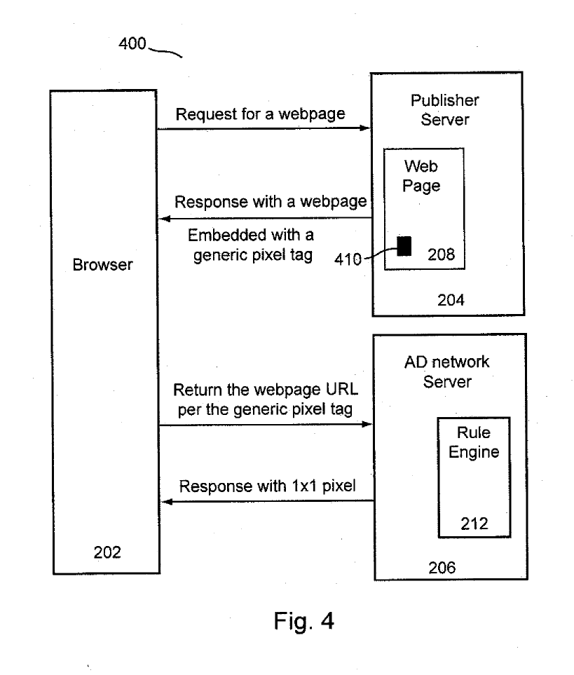

FIG. 4 is a block diagram illustrating an alternative Internet content delivering system 400 according to a second embodiment of the present invention. The system 400 differs from the system 200 of FIG. 2 in that in a response to the request from the browser 202, the server 204 releases the requested webpage with the generic pixel tag. Then the browser 202 sends a request to a server 206. The request contains the webpage URL information as instructed by the generic pixel tag. The system 400 spares the steps of sending a request for and receiving the Java scrip as the system 200 doses. The system 400 also employs the rule engine 212 for generating a relevant advertisement through determining a category of interest of the webpage.

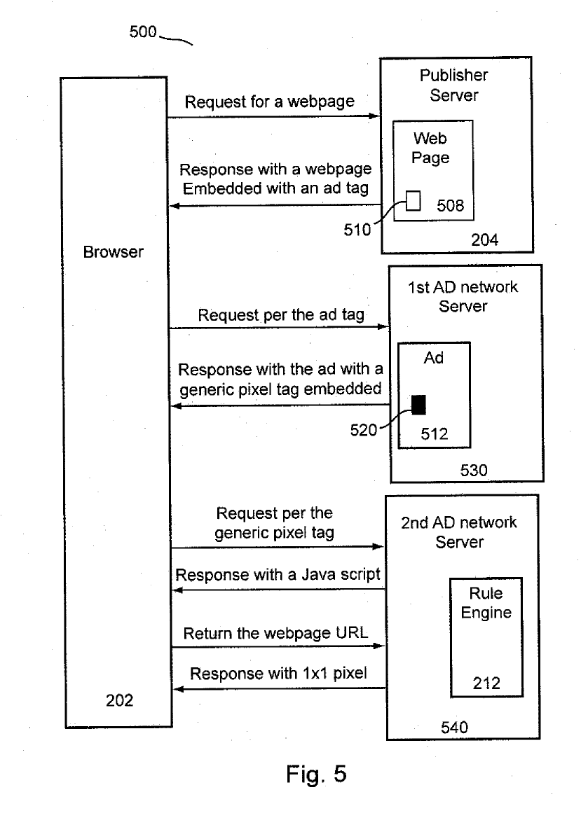

FIG. 5 is a block diagram illustrating yet another alternative Internet content delivering system 500 according to a third embodiment of the present invention. In system 500, a webpage 508 requested by the browser 202 contains only an advertisement tag 510 which calls for an advertisement content 512 residing in a first advertisement network server 530 to be sent to the browser 202. A generic pixel tag 520 is embedded in the advertisement content 512. The generic pixel tag 520 may be constructed similar to the generic pixel tag 210 of FIG. 2A, requesting a Java script from a second advertisement network server 540. The Java script obtains the URL of the webpage 508 and sends it to the second advertisement network server 540. The rule engine 212 in the second advertisement network server 540 determines a category of interest of the webpage based on the URL. This category is then used by the rule engine 212 to determine the interest model of the user (a set of categories of interest of the user maintained inside the rule engine 212). Then, at an appropriate moment, the second advertisement server 540 releases an advertisement content appropriate to the category of interest of the user.

The present invention is preferably implemented by software or a combination of hardware and software, but can also be implemented in hardware.

The present invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. An Internet content delivering system comprising:
a webpage embedded with a generic pixel tag stored in a first server, the generic pixel tag being configured to cause a retrieval of at least one predetermined attribute of the webpage from a browser viewing the webpage; and
a rule engine residing in a second server for determining one or more Internet contents based on the predetermined attribute for being sent to the browser,
wherein linkages between the webpage and the one or more Internet contents are not hard coded in the webpage.

2. The Internet content delivering system of claim 1, wherein the first server is a publisher server while the second server is an advertisement network server.

3. The Internet content delivering system of claim 1, wherein the generic pixel tag causes a script to be sent from the second server to the browser, wherein the script obtains the predetermined attribute of the webpage being viewed by the browser.

4. The Internet content delivering system of claim 3, wherein the script is written in Java language.

5. The Internet content delivering system of claim 1, wherein the predetermined attribute of the webpage is a part of a Uniform Resource Locator (URL).

6. The Internet content delivering system of claim 1, wherein the one or more Internet contents are advertisement contents.

7. The Internet content delivering system of claim 1, wherein the rule engine comprises an event qualification engine, a user modeler, and an optimizer, wherein the event qualification engine receiving the predetermined attribute and producing one or more webpage categories, the user modeler receiving the webpage category and determining interest categories of the user that is viewing the webpage, and the optimizer utilizing the interest categories of the user to determine the one or more Internet contents to be sent to the browser.

8. The Internet content delivering system of claim 7, wherein the event qualification engine comprises an exact map module, a rules module, and a rule-free module receiving the predetermined attribute and producing one or more webpage categories for determining the one or more Internet contents to be sent to the browser.

9. A method for automatically delivering relevant Internet contents, the method comprising:
releasing a webpage embedded with a generic pixel tag by a first server to a browser;
obtaining at least a first predetermined attribute of the webpage through an execution of the generic pixel tag on the browser;
sending the first predetermined attribute to a rule engine residing in a second server for determining at least a second predetermined attribute of the webpage; and
releasing one or more Internet contents appropriate to the second predetermined attribute,
wherein linkages between the webpage and the one or more Internet contents are not hard coded in the webpage.

10. The method of claim 9, wherein the first server is a publisher server while the second server is an advertisement network server.

11. The method of claim 9, wherein the execution of the generic pixel tag comprises:
calling the second server; and
releasing a script by the second server to the browser per the calling,
wherein the script obtains the predetermined attribute of the webpage on the browser.

12. The method of claim 11, wherein the script is written in Java language.

13. The method of claim 9, wherein the first predetermined attribute is at least a part of the URL of the webpage.

14. The method of claim 9, wherein the second predetermined attribute is an interest category of a user that is viewing the webpage.

15. The method of claim 9, wherein the one or more Internet contents are advertisement contents.

16. The Internet content delivering system of claim 9, wherein the rule engine comprises an event qualification engine, a user modeler, and an optimizer, wherein the event qualification engine producing the first predetermined attribute of the webpage, the user modeler receiving the first predetermined attribute of the webpage and determining the second predetermined attribute, and the optimizer utilizing the second predetermined attribute to determine the one or more Internet contents to be sent to the browser.

17. The Internet content delivering system of claim 16, wherein the event qualification engine comprises an exact map module, a rules module and a rule-free module producing the first predetermined attribute of the webpage for determining the one or more Internet contents to be sent to the browser.

18. A method for automatically delivering relevant Internet contents, the method comprising:
releasing a webpage embedded with a generic pixel tag by a publisher server to a browser;
obtaining at least one predetermined attribute of the webpage through an execution of the generic pixel tag on the browser;
sending the predetermined attribute to a rule engine residing in an advertisement network server for determining an interest category of a user viewing the webpage; and
releasing one or more Internet contents appropriate to the interest category,
wherein linkages between the webpage and the one or more Internet contents are not hard coded in the webpage.

19. The method of claim 18, wherein the execution of the generic pixel tag comprises:
calling the advertisement network server; and
releasing a script by the advertisement network server to the browser per the calling,
wherein the script obtains the predetermined attribute of the webpage on the browser.

20. The method of claim 19, wherein the script is written in Java script language.

21. The method of claim 18, wherein the predetermined attribute of the webpage is at least a part of the URL of the webpage.

22. The Internet content delivering system of claim 18, wherein the rule engine comprises an event qualification engine, a user modeler, and an optimizer, wherein the event qualification engine receiving the predetermined attribute and producing one or more webpage categories, the user modeler receiving the webpage category and determining interest categories of the user that is viewing the webpage, and the optimizer utilizing the interest categories of the user to determine the one or more Internet contents to be sent to the browser.

23. The Internet content delivering system of claim 22, wherein the event qualification engine comprises an exact map module, a rules module and a rule-free module receiving the predetermined attribute and producing one or more webpage category information for determining the one or more Internet contents to be sent to the browser.
